(19) United States
(12) Patent Application Publication
(10) Pub. No.: US 2026/0021612 A1
(43) Pub. Date: Jan. 22, 2026

(54) METHOD FOR ESTIMATING GAS CONCENTRATION IN MOLTEN RESIN IN INJECTION DEVICE FOR FOAM MOLDING

(71) Applicant: THE JAPAN STEEL WORKS, LTD., Tokyo (JP)

(72) Inventor: Akihiro NAITOU, Tokyo (JP)

(21) Appl. No.: 19/270,199

(22) Filed: Jul. 15, 2025

(30) Foreign Application Priority Data
Jul. 16, 2024 (JP) 2024-113526

(51) Int. Cl. B29C 44/60; B29C 44/34; B29C 44/42; B29K 23/00

(52) U.S. Cl. CPC B29C 44/60; B29C 44/3449; B29C 44/422; B29K 2023/12

(57) ABSTRACT

A gas concentration estimation method used in an injection device for foam molding configured to melt and feed a resin by rotating a screw in a heating cylinder, form a non-filled section in which molten resin is depressurized and the heating cylinder becomes a non-filled state, and supply gas to the non-filled section such that the gas dissolves in the molten resin, the method including estimating the gas concentration in the molten resin from following equation (c1) and a passing time T, which represents a time required for the resin to pass through the non-filled section

$$\frac{dC}{dt} = k ( {C}^{*} - C ) \qquad ( c1 )$$

where dC/dt: CHANGE RATE OF GAS CONCENTRATION IN MOLTEN RESIN [g/(m³s)]
k: CONSTANT [/s]
C*: SOLUBILITY OF GAS [g/m³]
C: GAS CONCENTRATION IN MOLTEN RESIN [g/m³]

### CROSS-REFERENCE TO RELATED APPLICATIONS

This application is based on and claims priority under 35 USC 119 from Japanese Patent Application No. 2024-113526 filed on Jul. 16, 2024, the entire content of which is incorporated herein by reference.

### TECHNICAL FIELD

The present disclosure relates to a gas concentration estimation method for estimating the concentration of a gas dissolved in a molten resin in an injection device used for foam molding, in which a gas is injected into a molten resin and the mixture is injected into a mold to obtain a foam molded article.

### BACKGROUND ART

A molded article containing a large number of fine bubbles therein, that is, a foam molded article is not only lightweight but also excellent in strength, and has a wide range of applications. In order to obtain a foam molded article by injection molding, it is necessary to mix a foaming agent into a resin. When a physical foaming agent is selected as the foaming agent, a gas such as nitrogen or carbon dioxide is used. When a gas is used as the foaming agent, the gas is injected into the resin melted in a heating cylinder, kneaded, and dissolved. When the mixture is injected into a mold, the pressure is released in the resin and the gas turns into bubbles. When the resin is cooled and solidified, a foam molded article is obtained.

When a foam molded article is molded using a gas, there is a method of injecting the gas in a supercritical state at high pressure and high temperature, but there is also a method of obtaining a foam molded article by injecting a gas at a relatively low pressure, as is performed by an injection molding machine described in JP2019-177696A. When such a method is performed, a groove depth of a screw is increased in a predetermined section of the screw, so that the pressure of the molten resin in the heating cylinder is reduced. That is, a starvation section is formed. The heating cylinder is provided with a gas injection portion corresponding to the starvation section, and the gas is injected into the gas injection portion. The gas permeates into the molten resin in the starvation section.

### SUMMARY OF INVENTION

When the starvation section is provided and the gas is injected to be dissolved in the molten resin, a gas injection device can be simply configured and can be implemented at low cost, which is advantageous. The gas concentration in the molten resin affects the quality of a foam molded article to be molded. However, there is a problem that it is unclear what the concentration of gas dissolved in the molten resin is.

An object of the present disclosure is to provide a method for estimating the concentration of a gas dissolved in a molten resin.

Other problems and novel features will become apparent from description of the present description and the accompanying drawings.

One illustrative aspect of the present disclosure provides a gas concentration estimation method used in an injection device for foam molding, the injection device including: a heating cylinder; a screw inserted into the heating cylinder and on which a flight is formed; and a gas supply unit. The injection device is configured to: melt a resin and feed the resin downstream by rotating the screw in the heating cylinder; form a non-filled section in which molten resin is depressurized and the heating cylinder becomes a non-filled state due to a shape of the flight; and cause the gas supply unit to supply gas to the non-filled section, such that the gas dissolves in the molten resin. A change rate dC/dt of gas concentration in molten resin, resulting from the gas dissolving into the molten resin via a gas-liquid interface between the gas and the molten resin in the non-filled section during rotation of the screw, is given by following equation (c1)

$$\frac{dC}{dt} = k ( {C}^{*} - C ) \qquad ( c1 )$$

where dC/dt: CHANGE RATE OF GAS CONCENTRATION IN MOLTEN RESIN [g/(m³s)]
k: CONSTANT [/s]
C*: SOLUBILITY OF GAS [g/m³]
C: GAS CONCENTRATION IN MOLTEN RESIN [g/m³]

the gas concentration estimation method including estimating the gas concentration in the molten resin from the equation (c1) and a passing time T, which represents a time required for the resin to pass through the non-filled section.

According to the present disclosure, the concentration of the gas dissolved in the molten resin can be estimated.

### BRIEF DESCRIPTION OF DRAWINGS

Illustrative embodiments of the present invention will be described in detail based on the following figures, wherein:

FIG. 1 is a front view showing an injection molding machine according to the present illustrative embodiment;

FIG. 2 is a front sectional view showing an injection device according to the present illustrative embodiment;

FIG. 3A is a front sectional view showing a part of the injection device according to the present illustrative embodiment;

FIG. 3B is a front sectional view showing a part of the injection device according to the present illustrative embodiment;

FIG. 4 is a view showing a cross section of a part of the injection device according to the present illustrative embodiment, a state in which the inside of a heating cylinder is developed along a direction of a flight, and a cross section of the inside of the heating cylinder cut in a direction orthogonal to the flight;

FIG. 5A is a front sectional view showing a part of the injection device according to the present illustrative embodiment;

FIG. 5B is a front sectional view showing a part of the injection device according to the present illustrative embodiment;

FIG. 6 is a front sectional view showing the injection device according to the present illustrative embodiment;

FIG. 7 is a flowchart showing a gas concentration estimation method according to a second illustrative embodiment;

FIG. 8A is a front sectional view showing a part of the injection device according to the present illustrative embodiment;

FIG. 8B is a front sectional view showing a part of the injection device according to the present illustrative embodiment;

FIG. 8C is a front sectional view showing a part of the injection device according to the present illustrative embodiment;

FIG. 9 is a flowchart showing a gas concentration estimation method according to a third illustrative embodiment;

FIG. 10 is a front sectional view showing a part of flight extruded molten resin;

FIG. 11 is a front sectional view showing the injection device according to the present illustrative embodiment;

FIG. 12 is a flowchart showing a gas concentration estimation method according to a fourth illustrative embodiment;

FIG. 13A is a graph showing gas concentrations in a molten resin obtained by an experiment;

FIG. 13B is a graph showing gas concentrations in the molten resin obtained by simulation 1;

FIG. 13C is a graph showing gas concentrations in the molten resin obtained by simulation 2; and

FIG. 13D is a graph showing gas concentrations in the molten resin obtained by simulation 3.

### DESCRIPTION OF EMBODIMENTS

Hereinafter, specific illustrative embodiments will be described in detail with reference to the drawings. The present disclosure is not limited to the following illustrative embodiments. In order to clarify the description, the following description and the drawings are simplified as appropriate. In the drawings, the same elements are denoted by the same reference numerals, and repeated description thereof is omitted as necessary. In addition, hatching may be omitted to avoid complicating the drawings.

### Injection Molding Machine

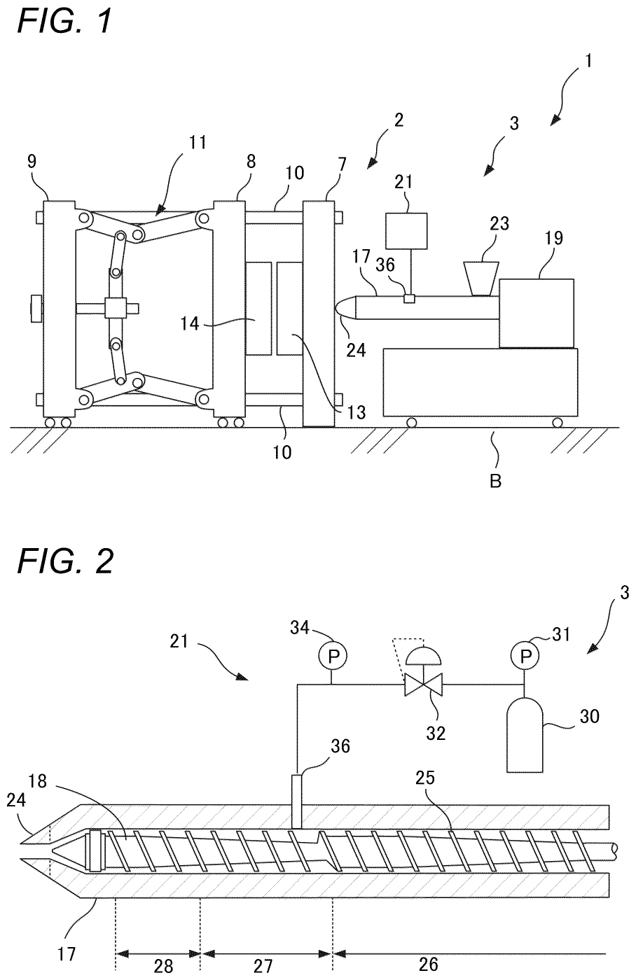

Hereinafter, the present illustrative embodiment will be described. A gas concentration estimation method according to the present illustrative embodiment is a method for estimating the concentration of a gas dissolved in a molten resin in a so-called injection molding machine for foam molding. The configuration of the injection molding machine is not particularly limited, but as an example, an injection molding machine 1 according to the present illustrative embodiment will be described with reference to FIG. 1. The injection molding machine 1 according to the present illustrative embodiment includes a mold clamping device 2 and an injection device 3.

### Mold Clamping Device

The mold clamping device 2 includes a fixed platen 7 fixed to a bed B, a movable platen 8 slidably provided on the bed B, and a mold clamping housing 9 also slidably provided on the bed B. The fixed platen 7 and the mold clamping housing 9 are coupled to each other by a plurality of tie bars 10, 10, . . . . The movable platen 8 is slidable between the fixed platen 7 and the mold clamping housing 9. A mold clamping mechanism, that is, a toggle mechanism 11 in the present illustrative embodiment is provided between the movable platen 8 and the mold clamping housing 9. The fixed platen 7 is provided with a fixed mold 13, and the movable platen 8 is provided with a movable mold 14. When the toggle mechanism 11 is driven, the fixed mold 13 and the movable mold 14 are opened and closed.

### Injection Device

As shown in FIGS. 1 and 2, the injection device 3 according to the present illustrative embodiment includes a heating cylinder 17, a screw 18 placed in the heating cylinder 17, a screw driving device 19, and a gas supply device 21. The screw 18 and the gas supply device 21 will be described in detail below. A hopper 23 is provided at a rear end portion, that is, upstream side, of the heating cylinder 17, and is adapted to supply resin pellets as a material. An injection nozzle 24 is provided on a tip end of the heating cylinder 17. Although not shown in FIGS. 1 and 2, the injection nozzle 24 includes a shut-off valve. The injection device 3 15 according to the present illustrative embodiment is configured to dissolve a gas in a molten resin and inject the mixture, and this is to close a resin flow path to prevent the molten resin in the injection nozzle 24 from foaming or dripping when the injection nozzle 24 is separated from the fixed mold 13.

The injection device 3 according to the present illustrative embodiment is characterized in the shape of the screw 18 in order to supply the gas into the heating cylinder 17 to dissolve the gas in the molten resin. Specifically, as shown in FIG. 2, the screw 18 has a groove depth between flights 25 that changes from the rear end portion, that is, the upstream side, to the tip end portion, that is, the downstream side. The depth of grooves between the flights 25 gradually becomes shallower from the upstream side to the midstream side, and then becomes deeper in a midstream portion. Then, the depth gradually becomes shallower again toward the downstream side.

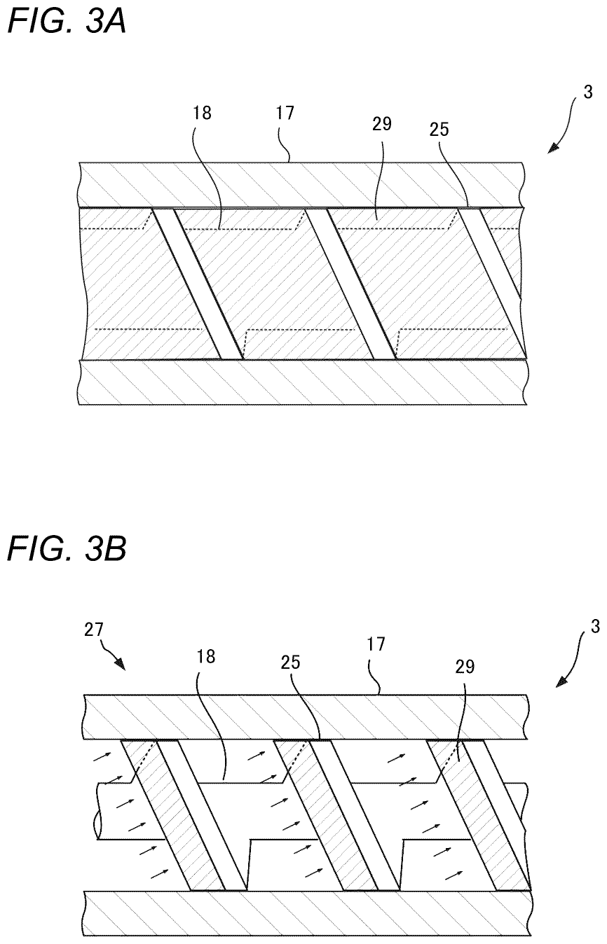

Since the screw 18 is formed in this manner, the inside of the heating cylinder 17 is divided into three sections 26, 27, and 28. That is, a first filled section 26 on the upstream side, a non-filled section 27 in the midstream portion, and a second filled section 28 on the 30 downstream side. The resin melts in the first filled section 26 to become the molten resin, and fills the heating cylinder 17. FIG. 3A shows a state in which the heating cylinder 17 is filled with a molten resin 29. The molten resin is then depressurized in the non-filled section 27. Then, as shown in FIG. 3B, the heating cylinder 17 is not filled with the molten resin 29. As described below, a gas is supplied to the non-filled section 27 and dissolved in the molten resin. The molten resin fills the heating cylinder 17 again in the second filled section 28 and is compressed.

As shown in FIG. 2, the gas supply device 21 includes a gas cylinder 30 that contains a gas such as carbon dioxide or nitrogen, a regulator 32 that reduces the gas pressure to a predetermined constant pressure, and gas pressure gauges 31 and 34 that measure the gas pressure. A gas injection portion 36 is provided at a location corresponding to the non-filled section 27 in the heating cylinder 17. The gas from the gas supply device 21 is supplied into the heating cylinder 17 at the gas injection portion 36. The supplied gas is dissolved in the molten resin 29 in the non-filled section 27 as shown in FIG. 3B.

### Gas Concentration Estimation Method according to First Illustrative Embodiment

A gas concentration estimation method according to a first illustrative embodiment will be described. The gas is dissolved in the molten resin 29 (see FIG. 3B) in the non-filled section 27 (see FIG. 2). More specifically, the gas is dissolved in the molten resin 29 from an interface with the molten resin 29, that is, a gas-liquid interface. An amount of change per unit time, that is, a change rate dC/dt of gas concentration C in the molten resin 29 that changes due to dissolution can be given by following Equation (1). Equation (1) is derived from Equation (3-1) which will be described later.

$$\frac{dC}{dt} = k ( {C}^{*} - C ) \qquad ( 1 )$$

where dC/dt: CHANGE RATE OF GAS CONCENTRATION IN MOLTEN RESIN [g/(m³s)]
k: CONSTANT [s]
C^{*}: SOLUBILITY OF GAS [g/m³]
C: GAS CONCENTRATION IN MOLTEN RESIN [g/m³]

The gas concentration can be calculated using Equation (1). For example, if the gas is carbon dioxide and the resin is polypropylene, the solubility C* of the gas is 2.72×10⁻² [g/m³] at 207° C. and 4 MPa. The constant k can be derived from a model of the behavior of the molten resin 29 in the non-filled section 27 as described later, or can be obtained from experiments. A method for deriving the constant from the model and a method for obtaining the constant from experiments will be described later. Here, it is assumed that the value of the constant k is given.

By transforming Equation (1) above, Equation (2-1) is obtained. By calculating Equation (2-1), Equation (2-2) is obtained.

$$\int \frac{1}{( C - {C}^{*} )} dC = - \int k dt \qquad ( 2 - 1 )$$

$$ln \vert C - {C}^{*} \vert = - k t + A \qquad ( 2 - 2 )$$

where A: INTEGRAL CONSTANT

$$A = ln {C}^{*} \qquad ( 2 - 3 )$$

$$ln \vert \frac{C - {C}^{*}}{{C}^{*}} \vert = - k t \qquad ( 2 - 4 )$$

$$\frac{{C}^{*} - C}{{C}^{*}} = exp ( - k t ) \qquad ( 2 - 5 )$$

$$C = ( 1 - exp ( - k t ) ) {C}^{*} \qquad ( 2 - 6 )$$

At t=0, that is, immediately after the molten resin starts to come into contact with the gas, the gas concentration C is 0. Substituting this into Equation (2-2), Equation (2-3) is obtained. Thus, Equation (2-2) can be transformed to obtain Equation (2-4). Equation (2-5) and Equation (2-6) can be obtained by modifying the equation while paying attention to the fact that the solubility C* of the gas is always greater than the gas concentration C in the molten resin and C*-C is positive.

In the gas concentration estimation method according to the first illustrative embodiment, the gas concentration of the molten resin is calculated by Equation (2-6). Specifically, a passing time T for the molten resin to pass through the non-filled section 27 (see FIG. 2) is substituted for a time t in Equation (2-6). Then, the gas concentration C of the molten resin after the passing time T seconds is obtained.

In the description of Equation (1), the constant k has been described as being able to be obtained by experiment. Specifically, the following may be performed. The injection device 3 (see FIG. 2) according to the present illustrative embodiment is used. The passing time T required for the molten resin to pass through the non-filled section 27 is measured. The passing time T is substituted into Equation (2-6). Then, the gas concentration C in the molten resin is given by a mathematical expression including the constant k. The gas concentration of the molten resin injected from the injection nozzle 24 of the injection device 3 is measured. The constant k is determined so that the calculated gas concentration C matches the measured value of the gas concentration. That is, the constant k can be obtained by experiments.

The gas concentration in the molten resin may be measured using any measuring device. For example, there is a method using a transmission type near-infrared spectroscopic probe. The transmission type near-infrared spectroscopic probe is attached to the injection nozzle 24 to obtain a near-infrared light absorption spectrum of the molten resin. Each type of gas absorbs infrared light at a specific wavelength. The gas concentration can be calculated by measuring a degree of absorption of the infrared light of the wavelength. For example, when carbon dioxide is used as the gas, light absorption at a wave number of 4950/cm (wavelength of 2.02 nm) may be examined. The constant k is determined by such an experiment. Then, the gas concentration C in the molten resin can be calculated by Equation (2-6).

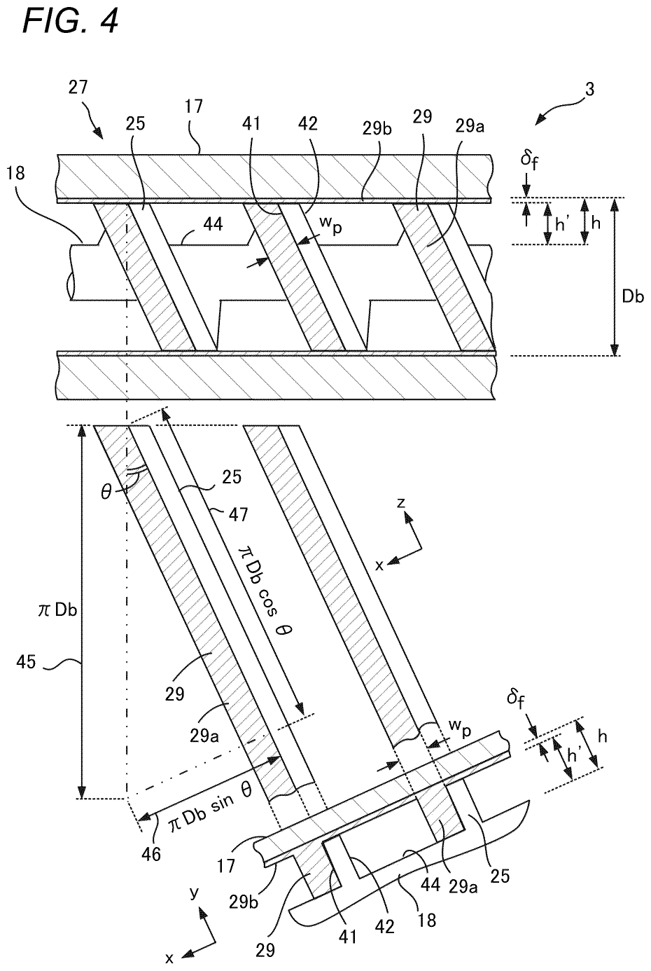

The constant k in Equation (1) can be derived from a model of the behavior of the molten resin 29 in the non-filled section 27. This will be described below. The upper part of FIG. 4 shows a state in which the molten resin 29 is extruded with a predetermined thickness by the flight 25 of the screw 18 in the non-filled section 27 of the heating cylinder 17. Of a pair of wall surfaces of the flight 25, the surface that extrudes the molten resin 29 is referred to as a push surface 41, and the other is referred to as a pull surface 42.

When the molten resin 29 in the non-filled section 27 is examined in detail, a large amount of molten resin 29a is extruded by the flight 25 with a predetermined thickness wₚ, and a very small amount of molten resin 29b adheres to an inner peripheral surface of the heating cylinder 17 with a thickness δ_{f}. The adhering molten resin 29b is molten resin leaking out from a gap between the top of the flight 25 and the heating cylinder 17. The molten resin 29a extruded by the flight 25 is extruded due to a height h′ of the flight 25. For the sake of convenience, hereinafter, the extruded molten resin 29a is referred to as flight extruded molten resin 29a, and the molten resin 29b leaking from the gap of the heating cylinder 17 and adhering to the inner peripheral surface of the heating cylinder 17 is referred to as cylinder adhering molten resin 29b.

The height h′ of the flight 25, a distance h between a groove 44 between the flights 25 and the inner peripheral surface of the heating cylinder 17, and the thickness of δ_{f} the cylinder adhering molten resin 29b are related by the following equation.

$${h}^{′} = h - {δ}_{f}$$

The thickness of δ_{f} the cylinder adhering molten resin 29b is sufficiently smaller compared to the flight height h, and can be treated as follows.

$${h}^{′} \approx h$$

The middle part of FIG. 4 shows a view in which the flight 25 formed in a spiral shape is linearly developed. The flight extruded molten resin 29a is similarly developed. A length of one revolution of the inner peripheral surface of the heating cylinder 17, that is, one revolution length 45, is given as πD_{b} from an inner diameter D_{b} [m] of the heating cylinder 17. With respect to the one revolution length 45, a component in a direction orthogonal to the flight 25, that is, an x-direction component 46, and a component in a direction parallel to the flight 25, that is, a z-direction component 47 are given as πD_{b} sin θ and πD_{b} cos θ, respectively, using a flight angle θ [rad] of the flight 25. When the screw 18 rotates at a rotation speed N [s⁻¹], the velocity at a predetermined point on the apex of the flight 25 is given by the product of the one revolution length 45 and the rotation speed N, and is therefore πD_{b}N. Then, of the velocity, a velocity component orthogonal to the flight 25 is given by πD_{b}N sin θ, and a velocity component parallel to the flight 25 is given by πD_{b}N cos θ.

The lower part of FIG. 4 shows a cross section perpendicular to the direction of the flight 25. The direction orthogonal to the flight 25 is defined as an x direction, and a height direction of the flight 25 is defined as a y direction. The constant k in Equation (1) is derived according to such a model.

When the gas and the molten resin are in contact with each other, the gas is dissolved in the molten resin from the gas-liquid interface. For the gas-liquid interface, that is, a surface of the molten resin, an average dissolution rate N_{gs} of the gas per unit time is given by the following Equation (3-1).

$${N}_{gs} = K ( {C}^{*} - C ) \qquad ( 3 - 1 )$$

where N_{gs}: AVERAGE DISSOLUTION RATE OF GAS [g/(m²s)]
K: SUBSTANCE TRANSFER COEFFICIENT [m/s]
C*: SOLUBILITY OF GAS [g/m³]
C: GAS CONCENTRATION IN MOLTEN RESIN [g/m³]

$$K = 2 \sqrt{\frac{{D}_{m}}{π τ}} \qquad ( 3 - 2 )$$

where Dₘ: DIFFUSION COEFFICIENT OF GAS [m²s]
τ: EXPOSURE TIME OF GAS [s]

$${N}_{gs} = 2 \sqrt{\frac{{D}_{m}}{π τ}} ( {C}^{*} - C ) \qquad ( 3 - 3 )$$

where N_{gs}: AVERAGE DISSOLUTION RATE OF GAS [g/(m²s)]
Dₘ: DIFFUSION COEFFICIENT OF GAS [m²/s]
τ: EXPOSURE TIME OF GAS [s]
C*: SOLUBILITY OF GAS [g/m³]
C: GAS CONCENTRATION IN MOLTEN RESIN [g/m³]

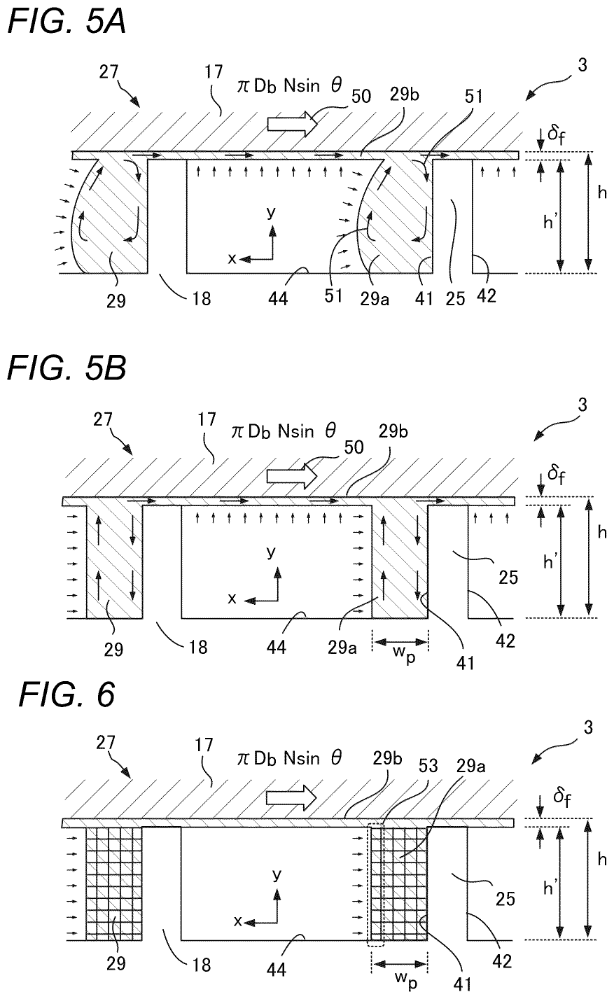

Incidentally, as for the substance transfer coefficient K, various expressions can be given by various theories such as a boundary film double hypothesis, but here, a model for surface renewal based on a so-called permeation theory is considered. That is, assuming that the gas-liquid interface is renewed due to flow of the flight extruded molten resin 29a, a renewal time of the gas-liquid interface, that is, the time t during which the resin is exposed to the gas, is given by Equation (3-2) as a parameter. This allows Equation (3-3) to be derived from Equations (3-1) and (3-2). As the screw 18 rotates in the heating cylinder 17, the spirally formed flight 25 appears to move relatively forward, that is, in a left direction in FIG. 5A in the heating cylinder 17. When the x-y coordinate is moved together with the flight 25 that appears to advance in the left direction in this way, the heating cylinder 17 relatively moves in a right direction as indicated by reference numeral 50 in FIG. 5A. The moving speed of the heating cylinder 17 in the right direction is πD_{b}N sin θ (D_{b}: inner diameter of the heating cylinder 17, θ: flight angle) when the screw 18 rotates at the rotation speed N [s⁻¹]. This is because, based on the consideration in FIG. 4, the velocity component orthogonal to the flight 25 when the screw 18 rotates is πD_{b}N sin θ.

At this time, the flight extruded molten resin 29a extruded by the push surface 41 of the flight 25 flows as indicated by arrows 51, 51, . . . . By such a flow, the surface of the flight extruded molten resin 29a, that is, the gas-liquid interface, moves upward at the same speed πD_{b}N sin θ as the moving speed of the heating cylinder 17 in the right direction. The flight extruded molten resin 29a has a shape in which the gas-liquid interface is convexly curved in the vicinity of a central portion as illustrated in FIG. 5A, but the gas-liquid interface is considered to be a vertical surface as illustrated in FIG. 5B.

In this case, the renewal time of the gas-liquid interface in the flight extruded molten resin 29a, that is, the exposure time τ during which the resin is in contact with the gas is the time when the gas-liquid interface passes through the height h′ of the flight, and thus is given by the following Equation (4).

$$τ = \frac{{h}^{′}}{π {D}_{b} N sin θ} \approx \frac{h}{π {D}_{b} N sin θ} \qquad ( 4 )$$

where τ: EXPOSURE TIME OF GAS [s]
h′: HEIGHT OF FLIGHT [m]
D_{b}: INNER DIAMETER OF HEATING CYLINDER [m]
N: ROTATION SPEED OF SCREW [/s]
θ: FLIGHT ANGLE [rad]
h: DISTANCE BETWEEN GROOVE BETWEEN FLIGHTS AND INNER PERIPHERAL SURFACE OF HEATING CYLINDER [m]

When the flight extruded molten resin 29a is treated as being united as a whole, the gas permeated from the gas-liquid interface permeates the entire flight extruded molten resin 29a and the gas concentration changes, so that the change rate dC/dt of the gas concentration C in the flight extruded molten resin 29a is given by the following Equation (5-1).

$$\frac{dC}{dt} = \frac{{N}_{gs} {S}_{p}}{{V}_{p}} \qquad ( 5 - 1 )$$

where dC/dt: CHANGE RATE OF GAS CONCENTRATION IN MOLTEN RESIN [g/(m³s)]
N_{gs}: AVERAGE DISSOLUTION RATE OF GAS [g/(m₂s)]
Sₚ: SURFACE AREA OF MOLTEN RESIN IN NON-FILLED SECTION [m²]
Vₚ: VOLUME OF MOLTEN RESIN IN NON-FILLED SECTION [m³]

$$\begin{matrix}{S}_{p} = {Lh}^{′} \approx Lh \\ {V}_{p} = {Lw}_{p} {h}^{′} \approx {Lw}_{p} h\end{matrix} \} \qquad ( 5 - 2 )$$

where L: LENGTH OF MOLTEN RESIN IN NON-FILLED SECTION [m]
h′: HEIGHT OF FLIGHT [m]
h: DISTANCE BETWEEN GROOVE BETWEEN FLIGHTS AND INNER PERIPHERAL SURFACE OF HEATING CYLINDER [m]
wₚ: THICKNESS OF MOLTEN RESIN ON PUSH SURFACE OF FLIGHT [m]

$$\frac{dC}{dt} = \frac{2}{{w}_{p}} \sqrt{\frac{{D}_{m} {D}_{b} N sin θ}{{h}^{′}}} ( {C}^{*} - C ) = \frac{2}{{w}_{p}} \sqrt{\frac{{D}_{m} {D}_{b} N sin θ}{h}} ( {C}^{*} - C ) \qquad ( 5 - 3 )$$

where wₚ: THICKNESS OF MOLTEN RESIN ON PUSH SURFACE OF FLIGHT [m]
Dₘ: DIFFUSION COEFFICIENT OF GAS [m²/s]
D_{b}: INNER DIAMETER OF HEATING CYLINDER [m]

N: ROTATION SPEED OF SCREW [/s]
θ: FLIGHT ANGLE [rad]
h′: HEIGHT OF FLIGHT [m]
C^{*}: SOLUBILITY OF GAS [g/m³]
C: GAS CONCENTRATION IN MOLTEN RESIN [g/m³]
h: DISTANCE BETWEEN GROOVE BETWEEN FLIGHTS AND INNER PERIPHERAL SURFACE OF HEATING CYLINDER [m]

When Equation (5-2) is substituted into Equation (5-1) and solved by Equations (3-3) and (4), Equation (5-3) is obtained. Comparing Equation (5-3) with Equation (1), the constant k is given by the following Equation (6-1). Repeating the above description, the constant k given by Equation (6-1) is obtained on the assumption that the flight extruded molten resin 29a is united as a whole and the gas permeates evenly throughout the entire flight extruded molten resin 29a.

$$k = \frac{2}{{w}_{p}} \sqrt{\frac{{D}_{m} {D}_{b} N sin θ}{{h}^{′}}} = \frac{2}{{w}_{p}} \sqrt{\frac{{D}_{m} {D}_{b} N sin θ}{h}} \qquad ( 6 - 1 )$$

where k: CONSTANT [/s]
wₚ: THICKNESS OF MOLTEN RESIN ON PUSH SURFACE OF FLIGHT [m]
Dₘ: DIFFUSION COEFFICIENT OF GAS [m²/s]

D_{b}: INNER DIAMETER OF HEATING CYLINDER [m]
N: ROTATION SPEED OF SCREW [/s]
θ: FLIGHT ANGLE [rad]
h′: HEIGHT OF FLIGHT [m]
h: DISTANCE BETWEEN GROOVE BETWEEN FLIGHTS AND INNER PERIPHERAL SURFACE OF HEATING CYLINDER [m]

Here, a diffusion coefficient Dₘ of gas varies depending on the type of resin or gas and temperature. For example, when carbon dioxide is dissolved and diffused in polypropylene at a temperature of 190° C., the diffusion coefficient is 8.0×10⁻⁹ [m²/s]. For other constants, for example, a thickness wₚ of the molten resin, an inner diameter D_{b} of the heating cylinder, and the like, appropriate numerical values are used and substituted into Equation (6-1) to obtain the value of the constant k. The description of the method for deriving the constant k by the model of the behavior of the molten resin 29 ends.

### Gas Concentration Estimation Method According to Second Illustrative Embodiment

A gas concentration estimation method according to a second illustrative embodiment will be described. In the gas concentration estimation method according to the second illustrative embodiment, the calculation is performed in consideration of not only the dissolution of the gas from the gas-liquid interface into the molten resin, but also a change in the gas concentration due to the flow of the molten resin. FIG. 6 shows a model for implementing the gas concentration estimation method according to the second illustrative embodiment. Of the molten resin 29, the flight extruded molten resin 29a is divided into a plurality of meshes in a lattice shape. In FIG. 6, the mesh is divided into a plurality of units in the x direction and the y direction, and the mesh is also divided in a z direction into a short predetermined width. The gas concentration of the flight extruded molten resin 29a is estimated by calculation using a mesh. In the second illustrative embodiment, the cylinder adhering molten resin 29b is excluded from the calculation of the gas concentration. The reason for this is that compared with the flight extruded molten resin 29a, the cylinder adhering molten resin 29b has a small thickness of and a small volume, and has a relatively small influence on the gas concentration of the entire molten resin 29.

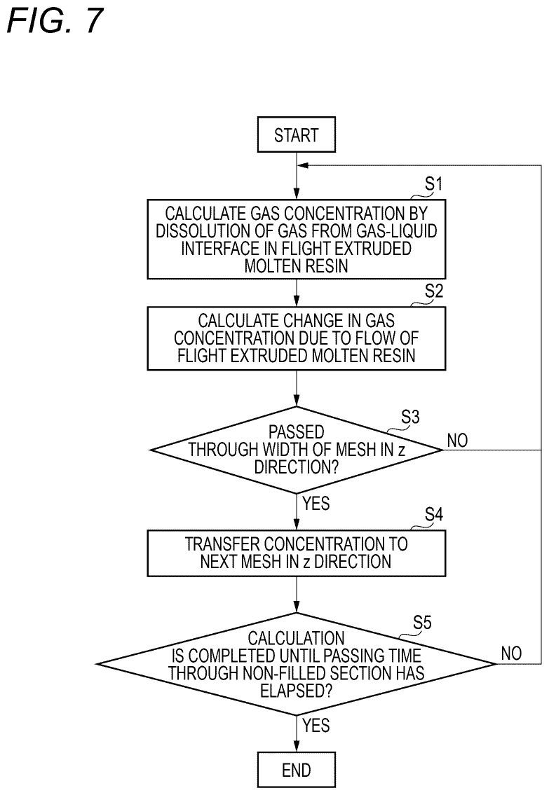

The gas concentration estimation method according to the second illustrative embodiment is performed as shown in FIG. 7. The molten resin of a predetermined width in the z direction is to be calculated. The calculation is started immediately after the molten resin of the predetermined width enters the non-filled section 27. First, step S1 is performed. That is, among the plurality of meshes of the flight extruded molten resin 29a (see FIG. 6), for the meshes serving as the gas-liquid interface, that is, the meshes indicated by reference numeral 53, the dissolution of the gas in a short time Δt is calculated. The calculation is performed by Equation (1), and the constant k uses the following Equation (6-2). In the same manner as the derivation of Equation (6-1), Equation (6-2) is obtained on the assumption that, in a mesh in contact with the gas, that is, a mesh that belongs to the gas-liquid interface, the gas permeates evenly into the mesh.

$$k = \frac{2}{{d}_{x}} \sqrt{\frac{{D}_{m} {D}_{b} N sin θ}{{h}^{′}}} = \frac{2}{{d}_{x}} \sqrt{\frac{{D}_{m} {D}_{b} N sin θ}{h}} \qquad ( 6 - 2 )$$

where k: CONSTANT [/s]
dₓ: THICKNESS OF MESH (DEPTH IN X DIRECTION FROM GAS-LIQUID INTERFACE) [m]
Dₘ: DIFFUSION COEFFICIENT OF GAS [m²/s]
D_{b}: INNER DIAMETER OF HEATING CYLINDER [m]
N: ROTATION SPEED OF SCREW [/s]
θ: FLIGHT ANGLE [rad]
h′; HEIGHT OF FLIGHT [m]
h: DISTANCE BETWEEN GROOVE BETWEEN FLIGHTS AND INNER PERIPHERAL SURFACE OF HEATING CYLINDER [m]

For example, the following calculation is performed. By transforming Equation (1), Equation (7-1) is obtained. In this way, if the gas concentration in the molten resin at a predetermined time is C, gas concentration C_{new} after the minute time Δt seconds is given by Equation (7-2). Since the gas concentration is 0 immediately after the start of contact with the gas, the initial gas concentration C=0 is set as the boundary condition.

$$Δ C = k ( {C}^{*} - C ) \times Δ t \qquad ( 7 - 1 )$$

where ΔC: AMOUNT OF CHANGE IN GAS CONCENTRATION IN MOLTEN RESIN [g/m³]
k: CONSTANT [/s]
C^{*}: SOLUBILITY OF GAS [g/m³]
C: GAS CONCENTRATION IN MOLTEN RESIN [g/m³]

$${C}_{new} = C + k ( {C}^{*} - C ) \times Δ t \qquad ( 7 - 2 )$$

where C_{new}: GAS CONCENTRATION IN MOLTEN RESIN AFTER At SECONDS [g/m³]

After the calculation in step S1 is performed for the meshes corresponding to reference numeral 53 in FIG. 6 and the gas concentration C_{new} is calculated for each mesh, the process proceeds to step S2 as shown in FIG. 7. In step S2, the gas concentration in each mesh of the flight extruded molten resin 29a is calculated in consideration of the flow of each mesh. The change in the gas concentration of each mesh due to the flow can be calculated using the following Equation (8-1). This Equation (8-1) is an equation obtained using a so-called advection diffusion Equation (8-3), which is a general equation for the gas concentration change, where the concentration change due to diffusion is small compared to the magnitude of the concentration change due to flow, and the left side is 0. However, here, Equation (8-1) is further simplified. That is, Equation (8-2) is obtained assuming that the resin flows only in the xy directions and a flow velocity v_{z} in the z direction is 0. The calculation is performed in this way. Note that the flow velocity v_{z} in the z direction is not naturally zero, and is considered in the following steps S3 and S4.

$$\frac{\partial C}{\partial t} + ( v \cdot ∇ C ) = \frac{\partial C}{\partial t} + {v}_{x} \frac{\partial C}{\partial x} + {v}_{y} \frac{\partial C}{\partial y} + {v}_{z} \frac{\partial C}{\partial z} = 0 \qquad ( 8 - 1 )$$

where C: GAS CONCENTRATION IN MOLTEN RESIN [g/m³]
v: FLOW VELOCITY OF RESIN [m/s]
vₓ: x-DIRECTION COMPONENT OF FLOW VELOCITY OF RESIN [m/s]
v_{y}: y-DIRECTION COMPONENT OF FLOW VELOCITY OF RESIN [m/s]
V_{z}: z-DIRECTION COMPONENT OF FLOW VELOCITY OF RESIN [m/s]

$$\frac{\partial C}{\partial t} + {v}_{x} \frac{\partial C}{\partial x} + {v}_{y} \frac{\partial C}{\partial y} = 0 \qquad ( 8 - 2 )$$

$$\frac{\partial C}{\partial t} + ( v ∇ C ) = {D}_{m} {∇}^{2} C \qquad ( 8 - 3 )$$

where δC/δt: CHANGE RATE OF GAS CONCENTRATION IN MOLTEN RESIN [g/(m³s)]
v: FLOW VELOCITY OF MOLTEN RESIN [m/s]
Dₘ: DIFFUSION COEFFICIENT OF GAS [m²/s]
C: GAS CONCENTRATION IN MOLTEN RESIN [g/m³]

For example, the flow velocity can be calculated using commercially available flow analysis software. For example, for any one mesh, the flow velocity at which the resin flows out to one or more adjacent meshes after At seconds and the flow velocity at which the resin flows into the one mesh from one or more adjacent meshes are calculated using the flow analysis software. Then, the gas concentration after At seconds is calculated from the respective gas concentrations in these meshes, an outflow amount from the one mesh, and an inflow amount into the one mesh. This calculation is performed for all meshes.

When the calculation in step S2 is completed, step S3 is executed as shown in FIG. 7. That is, a check is made to see whether the resin has passed through the width of the mesh in the z direction. This will be described in detail. First, the flight extruded molten resin 29a advances in the z direction at an average velocity in the z direction of πD_{b}N cos θ/2 (D_{b}: inner diameter of the heating cylinder 17, N: rotation speed of the screw 18, θ: flight angle). The average velocity in the z direction is given based on the assumption that the velocity component in the z direction at the top of the flight 25 is πD_{b}N cos θ, which is obtained by the consideration in FIG. 4, the assumption that the velocity component in the z direction of the resin at the bottom of the flight 25 is 0, and the assumption that the speed velocity in the z direction linearly increases in the height direction of the flight 25. Hereinafter, it is assumed that the flight extruded molten resin 29a uniformly flows at an average velocity πD_{b}N cos θ/2 in the z direction regardless of the height of the flight 25. That is, it is considered that the entire mesh advances in the z direction at an average flow velocity v_{z}=πD_{b}N cos θ/2 in the z direction. According to the average flow velocity v_{z}, in the first calculation, the flow advances in the z direction by the first Δt seconds, that is, πD_{b}N cosθΔt/2. A check is made to see whether an advanced distance has passed through the width of the mesh in the z direction. If not, the determination is NO, and the process returns to step S1.

In step S1, the calculation for the next Δt seconds is performed, that is, the dissolution of the gas from the gas-liquid interface for the meshes indicated by reference numeral 53 in FIG. 6 is calculated by Equation (7-2), and C_{new} after the next Δt seconds is calculated. Next, in step S2, a change in gas concentration due to the flow is calculated. Step S3 is executed again. If the distance advanced in the z direction by the average flow velocity v_{z} has not passed through the width of the mesh in the z direction (NO), the process returns to step S1 again, and if the distance has passed (YES), the process proceeds to step S4. In step S4, the gas concentration in each mesh is transferred to the next mesh group in the z direction, that is, the downstream mesh group. That is, it is assumed that the gas concentration has moved from the upstream mesh group to the adjacent downstream mesh group due to the average flow velocity v_{z} in the z direction.

After step S4 is executed, step S5 is executed. That is, it is determined whether the flight extruded molten resin 29a that is the subject of the calculation has passed through the non-filled section, that is, whether the passing time has elapsed. If the passing time has not elapsed (NO), the process returns to step S1. If the passing time has elapsed (YES), the processing ends. In step S5, it is determined whether the flight extruded molten resin 29a has passed through the non-filled section. Alternatively, it may be determined whether a metering time has elapsed, and the calculation is ended when the metering time has elapsed. The description of the gas concentration estimation method according to the second illustrative embodiment ends.

### Gas Concentration Estimation Method According to Third Illustrative Embodiment

A gas concentration estimation method according to a third illustrative embodiment will be described. In the gas concentration estimation method according to the third illustrative embodiment, the calculation is performed in consideration of the dissolution of the gas from the gas-liquid interface into the molten resin, the mixing of the cylinder adhering molten resin 29b (see FIG. 5B) into the flight extruded molten resin 29a, and the change in the gas concentration due to the flow of the molten resin.

In the gas concentration estimation method according to the third illustrative embodiment, a method is proposed in which a commercially available flow analysis software is not required so that calculation can be performed even on a personal computer or the like that does not have sufficient computing power when calculating the change in the gas concentration due to the flow of the molten resin. Therefore, the number of meshes of the flight extruded molten resin 29a is reduced so that the flow can be calculated relatively simply. In determining the size of the mesh or the like, the flow of the flight extruded molten resin 29a is considered.

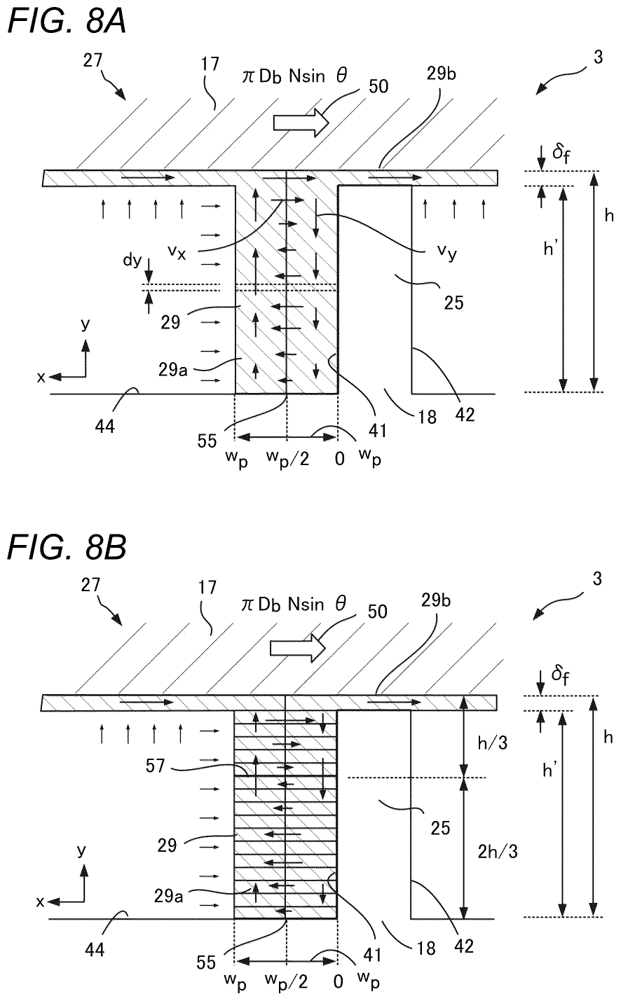

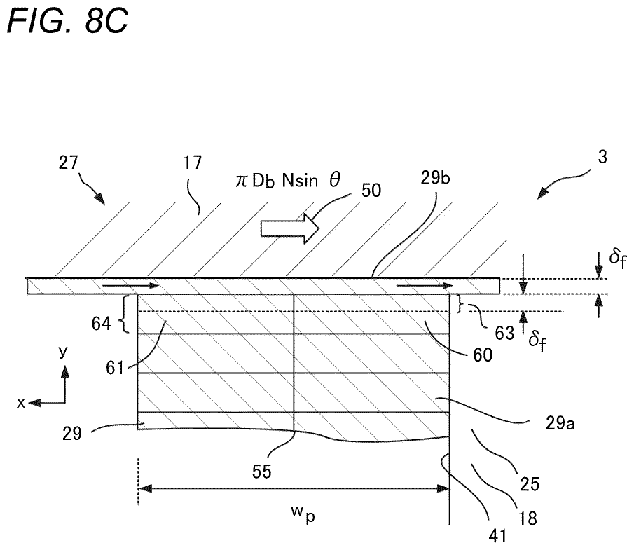

As shown in FIG. 8A, the flight extruded molten resin 29a in a cross section perpendicular to the flight 25 is considered as being divided into two in the x direction. That is, a virtual boundary 55 is considered at x=wₚ/2. The flow velocity vₓ of the molten resin in the x direction at the boundary 55 changes in magnitude depending on a y position and is a function of y. The groove 44 between the flights 25 and 25 is fixed, and the inner peripheral surface of the heating cylinder 17 slides at a speed of πD_{b}N sin θ(D_{b}: inner diameter of the heating cylinder 17, N: rotation speed of the screw 18, θ: flight angle). The boundary 55, which is located at half the thickness of the flight extruded molten resin 29a, is a symmetrical plane of the molten resin. Therefore, it can be considered that the flow velocity vₓ of the molten resin at the boundary 55 is a steady flow of a viscous fluid flowing between so-called parallel plates. Then, the flow velocity vₓ of the molten resin in the x direction at the boundary 55 can be expressed by Equation (9-1) as a superposition of a so-called Couette flow and a two-dimensional Poiseuille flow.

$${v}_{x} = \{ \frac{y}{h} π {D}_{b} N sin θ - \frac{1}{2 η} \frac{\partial P}{\partial x} ( {y}^{2} - hy ) \} \qquad ( 9 - 1 )$$

where vₓ: x-DIRECTION COMPONENT OF FLOW VELOCITY OF RESIN (m/s)
h: DISTANCE BETWEEN GROOVE BETWEEN FLIGHTS AND INNER PERIPHERAL SURFACE OF HEATING CYLINDER [m]
D_{b}: INNER DIAMETER OF HEATING CYLINDER [m]
N: ROTATION SPEED OF SCREW [/s]
θ: FLIGHT ANGLE [rad]
η: VISCOSITY OF MOLTEN RESIN [Pa·s]
P: PRESSURE OF MOLTEN RESIN [Pa]

$${Qv}_{x} = dz {\int }_{0}^{h} {v}_{x} dy = - dz ( \frac{π {D}_{b} N sin θ}{2} - \frac{{h}^{3}}{12 η} \frac{\partial P}{\partial x} ) \qquad ( 9 - 2 )$$

where Qvₓx-DIRECTION COMPONENT OF VOLUME FLOW RATE OF RESIN [m³/s]
vₓx-DIRECTION COMPONENT OF FLOW VELOCITY OF RESIN [m/s]
h INNER DIAMETER OF HEATING CYLINDER [m]
D_{b}: DISTANCE BETWEEN GROOVE BETWEEN FLIGHTS AND INNER PERIPHERAL SURFACE OF HEATING CYLINDER [m]
N: ROTATION SPEED OF SCREW [/s]
θ: FLIGHT ANGLE [rad]
η:VISCOSITY OF MOLTEN RESIN [Pa·s]
P: PRESSURE OF MOLTEN RESIN [Pa]

When a width in the z direction (see FIG. 4) is dz and a volume flow rate Qvₓ in the x direction of the molten resin over the entire surface of the boundary 55 is considered, the volume flow rate Qvₓ is obtained as in Equation (9-2) by integrating Equation (9-1) in the y direction. In the flight extruded molten resin 29a, the thickness Wp of the molten resin is treated as being constant in the z direction (see FIG. 4). In this way, the thickness Wp of the molten resin does not change with time. In this case, the volume flow rate Qvₓ is zero. When Equation (9-2) is set to zero, Equation (10-1) is obtained. It is substituted into Equation (9-1) to obtain Equation (10-2).

$$\frac{1}{2 η} \frac{\partial P}{\partial x} = \frac{3 π {D}_{b} N sin θ}{{h}^{2}} \qquad ( 10 - 1 )$$

where η: VISCOSITY OF MOLTEN RESIN [Pa·s]
PRESSURE OF MOLTEN RESIN [Pa]
h: DISTANCE BETWEEN GROOVE BETWEEN FLIGHTS AND INNER PERIPHERAL SURFACE OF HEATING CYLINDER [m]
D_{b};INNER DIAMETER OF HEATING CYLINDER [m]
N: ROTATION SPEED OF SCREW [/s]
θ: FLIGHT ANGLE [rad]

$${v}_{x} = - π {D}_{b} N sin θ \{ 3 {( \frac{y}{h} )}^{2} - 2 \frac{y}{h} \} \qquad ( 10 - 2 )$$

where vₓ: x-DIRECTION COMPONENT OF FLOW VELOCITY OF RESIN [m/s]
h: DISTANCE BETWEEN GROOVE BETWEEN FLIGHTS AND INNER PERIPHERAL SURFACE OF HEATING CYLINDER [m]
D_{b}INNER DIAMETER OF HEATING CYLINDER [m]
N: ROTATION SPEED OF SCREW [/s]
ƒ: FLIGHT ANGLE [rad]

Next, the flow velocity v_{y} of the molten resin in the y direction is considered for a right half side in FIG. 8A, that is, a range of 0≤x≤wₚ/2 and for a left half side, that is, a range of wₚ/2≤x≤wₚ of the flight extruded molten resin 29a. On the right half side, an amount of molten resin flowing from the left half side to the right half side within the width dy at the boundary 55 is −vₓdy per unit width in the z direction. An amount by which the flow velocity v_{y} increases due to the amount −vₓdy of the molten resin flowing in this way is −vₓdy×2/wₚ. On the left half side, an amount of molten resin flowing from the right half side to the left half side within the width dy at the boundary 55 is vₓdy per unit width in the z direction. An amount by which the flow velocity v_{y} increases due to the amount vₓdy of the molten resin flowing in this way is vₓdy×2/wₚ. Since the flow velocity of the molten resin on both the right half side and the left half side satisfies v_{y}=0 when y=0, the flow velocity v_{y} of the molten resin on the left half side and the right half side at any y position y* is given by Equation (11).

$$when \\ 0 \leq x \leq \frac{{w}_{p}}{2} , \\ {v}_{y} = - {\int }_{0}^{y *} \frac{2 {v}_{x}}{{w}_{p}} dy = \frac{2 π {D}_{b} N sin θ}{{w}_{p}} ( \frac{{y}^{* 3}}{{h}^{2}} - \frac{{y}^{* 2}}{h} ) \\ when \\ \frac{{w}_{p}}{2} \leq x \leq {w}_{p} , \\ {v}_{y} = {\int }_{0}^{y *} \frac{2 {v}_{x}}{{w}_{p}} dy = - \frac{2 π {D}_{b} N sin θ}{{w}_{p}} ( \frac{{y}^{* 3}}{{h}^{2}} - \frac{{y}^{* 2}}{h} ) \qquad ( 11 )$$

where vₓ: x-DIRECTION COMPONENT OF FLOW VELOCITY OF RESIN [m/s]
h. DISTANCE BETWEEN GROOVE BETWEEN FLIGHTS AND INNER PERIPHERAL SURFACE OF HEATING CYLINDER [m]
D_{b}: INNER DIAMETER OF HEATING CYLINDER [m]
N: ROTATION SPEED OF SCREW [/s]
θ: FLIGHT ANGLE [rad]
y*: ANY y COORDINATE

Here, division of the mesh of the flight extruded molten resin 29a in the x direction and the y direction will be considered. As illustrated in FIG. 8B, in the x direction, division is performed at the boundary 55, that is, x=wₚ/2. In the y direction, it is divided into a plurality of meshes having a low height. In the gas concentration estimation method according to the third illustrative embodiment, when the change in the gas concentration due to the flow of the molten resin is calculated, the gas concentration of the flight extruded molten resin 29a is calculated based on the meshes divided in this manner. By the way, at a height of 2 h/3 from the groove 44 between the flights 25 and 25, that is, at the boundary 57 at y=2 h/3, vₓ=0 from Equation (10-2). That is, the flow velocity vₓ of the molten resin in the x direction becomes 0 at the boundary 57. The flow velocity vₓ in the x direction has a positive magnitude below the boundary 57 and a negative magnitude above the boundary 57.

In the gas concentration estimation method according to the third illustrative embodiment, a change in the gas concentration due to mixing of the cylinder adhering molten resin 29b into the flight extruded molten resin 29a is also calculated. The thickness δ_{f} of the cylinder adhering molten resin 29b is generally as thin as about 0.1 mm to 0.2 mm. Therefore, it is considered that the gas quickly permeates and quickly reaches the solubility C* of the gas. Thus, the cylinder adhering molten resin 29b, which has reached the solubility C* of the gas, moves at πD_{b}N sin θ and comes into contact with the flight extruded molten resin 29a. That is, as shown in FIG. 8C, the cylinder adhering molten resin 29b comes in contact with meshes 60 and 61 at the top of the flight extruded molten resin 29a. As a result, a part of the molten resin in the meshes 60 and 61 is mixed with the cylinder adhering molten resin 29b.

In the gas concentration estimation method according to the third illustrative embodiment, it is assumed that, in the uppermost meshes 60 and 61, the molten resin in the range of thickness δ_{f} indicated by reference numeral 63 in FIG. 8C is mixed with the cylinder adhering molten resin 29b having the thickness δ_{f}. As a result, the cylinder adhering molten resin 29b having the solubility C* of the gas permeates at a speed of πD_{b}N sin θ, and is mixed with the molten resin in the meshes 60 and 61 having the gas concentration C and the thickness wₚ. Therefore, an amount of change in the gas concentration in the molten resin indicated by reference numeral 63 is given by Equation (12). Using this Equation (12), the gas concentration of the molten resin of the meshes 60 and 61 due to mixing with the cylinder adhering molten resin 29b can be calculated. The molten resin having the thickness δ_{f} and indicated by reference numeral 63 is considered to be uniformly mixed with the molten resin in the meshes 60 and 61 having a thickness indicated by reference numeral 64. [JP0056]

$$\frac{\partial C}{\partial t} = \frac{π {D}_{b} N sin θ ( {C}^{*} - C )}{2 {w}_{p}} \qquad ( 12 )$$

where C: GAS CONCENTRATION IN MOLTEN RESIN [g/m³]
D_{b}: INNER DIAMETER OF HEATING CYLINDER [m]
N: ROTATION SPEED OF SCREW [/s]
θ: FLIGHT ANGLE [rad]
C^{*}: SOLUBILITY OF GAS [g/m³]
wₚ: THICKNESS OF EXCLUDED MOLTEN RESIN BY FLIGHT [m]

When the gas concentration estimation method according to the third illustrative embodiment is performed, the thickness wₚ of the flight extruded molten resin 29a is required. The thickness wₚ can be obtained by experiments or by calculation. A method for obtaining the thickness by calculation will be described. First, the flow velocity v_{z} of the molten resin in the z direction of the flight extruded molten resin 29a is considered. The flow velocity v_{z} of the molten resin in the z direction changes depending on the y position and is a function of y. The groove 44 between the flights 25 and 25 is fixed, and with reference to the considerations in FIG. 4, the inner peripheral surface of the heating cylinder 17 slides at a speed of πD_{b}N cos θ (D_{b}: inner diameter of the heating cylinder 17, N: rotation speed of the screw 18, θ: flight angle). Then, the flow velocity v_{z} of the molten resin in the z direction is given by Equation (13-1) in the same manner as Equation (9-1) as a superposition of a so-called Couette flow and a two-dimensional Poiseuille flow.

[JP0058]

$${v}_{z} = \frac{y}{h} π {D}_{b} N cos θ - \frac{1}{2 η} \frac{δ P}{δ z} ( {y}^{2} - hy ) \qquad ( 13 - 1 )$$

where v_{z}: z-DIRECTION COMPONENT OF FLOW VELOCITY OF RESIN [m/s]
h: DISTANCE BETWEEN GROOVE BETWEEN FLIGHTS AND INNER PERIPHERAL SURFACE OF HEATING CYLINDER [m]
D_{b}: INNER DIAMETER OF HEATING CYLINDER [m]
N: ROTATION SPEED OF SCREW [/s]
θ: FLIGHT ANGLE [rad]
η: VISCOSITY OF MOLTEN RESIN [Pa·s]
P PRESSURE OF MOLTEN RESIN [Pa]

$${v}_{z} = \frac{y}{h} π {D}_{b} N cos θ \qquad ( 13 - 2 )$$

$${Qv}_{z} = {n}_{f} {w}_{p} {\int }_{0}^{h} {v}_{z} dy = \frac{π {D}_{b} N {hn}_{f} {w}_{p} cos θ}{2} \qquad ( 13 - 3 )$$

where Qv_{z}: VOLUME FLOW RATE OF MOLTEN RESIN IN z DIRECTION [m³/s]
n₇₁ : NUMBER OF STARTS OF FLIGHT THREADS [-]
wₚ: THICKNESS OF EXCLUDED MOLTEN RESIN BY FLIGHT [m]
v_{z}: z-DIRECTION COMPONENT OF FLOW VELOCITY OF RESIN [m/s]
h DISTANCE BETWEEN GROOVE BETWEEN FLIGHTS AND INNER PERIPHERAL SURFACE OF HEATING CYLINDER [m]
D_{b}: INNER DIAMETER OF HEATING CYLINDER [m]
N: ROTATION SPEED OF SCREW [/s]
θ: FLIGHT ANGLE [rad]

Since it is considered that the pressure gradient δP/δz of the molten resin in the z direction is 0 in the non-filled section 27, Equation (13-2) is obtained from Equation (13-1). Then, the volume flow rate Qv_{z} in the z direction in the non-filled section 27 is obtained by multiplying the number of starts of flight threads n_{f}, the thickness wₚ of the flight extruded molten resin 29a, and an integral of the flow velocity v_{z} indicated by (13-2) in the y direction, as in Equation (13-3).

On the other hand, in the injection device 3 (see FIG. 2), when the screw 18 is rotated to feed the molten resin, the molten resin is metered at a tip end of the heating cylinder 17. Then, the volume flow rate Qₘ of the molten resin in an axial direction of the heating cylinder 17 at the time of metering is given by Equation (14) from a length Lₛₜ of the molten resin to be metered and a metering time tᵣ.

$${Q}_{m} = \frac{π {( {D}_{b} / 2 )}^{2} {L}_{st}}{{t}_{r}} \qquad ( 14 )$$

where Qₘ: VOLUME FLOW RATE OF MOLTEN RESIN IN AXIAL DIRECTION OF HEATING CYLINDER [m³/s]
D_{b}: INNER DIAMETER OF HEATING CYLINDER [m]
Lₛₜ: LENGTH OF METERED MOLTEN RESIN AT TIP END OF HEATING CYLINDER [m]
tᵣ: METERING TIME [s]

Here, assuming that the volume flow rate Qv_{z} of the molten resin in the z direction given by Equation (13-3) is equal to the volume flow rate Qₘ in the axial direction given by Equation (14), by solving Qv_{z}=Qₘ, the thickness wₚ of the flight extruded molten resin 29a is obtained.

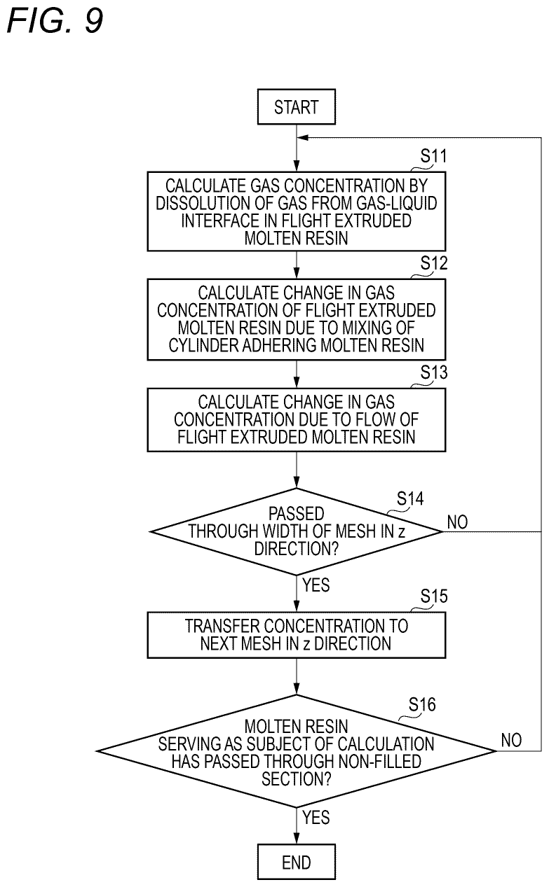

The gas concentration estimation method according to the third illustrative embodiment will be described with reference to the flowchart of FIG. 9. The calculation starts immediately after the molten resin of a predetermined width enters the non-filled section 27 (see FIG. 4). First, step S11 is performed. That is, among the plurality of meshes of the flight extruded molten resin 29a (see FIG. 8B), for the meshes serving as the gas-liquid interface, that is, the meshes on the left side, the dissolution of the gas in a short time Δt is calculated. The calculation is performed using Equation (1), and the constant k is a numerical value obtained by Equation (6-2) described in the second illustrative embodiment, that is, a numerical value calculated by assuming that a thickness dₓ of the mesh in this equation is ½ of the thickness wₚ of the flight extruded molten resin 29a (dₓ=wₚ/2).

Next, step S12 is performed. That is, a change in the gas concentration due to mixing of the cylinder adhering molten resin 29b into the flight extruded molten resin 29a is calculated. That is, the gas concentration is calculated for the meshes 60 and 61 shown in FIG. 8C based on Equation (12).

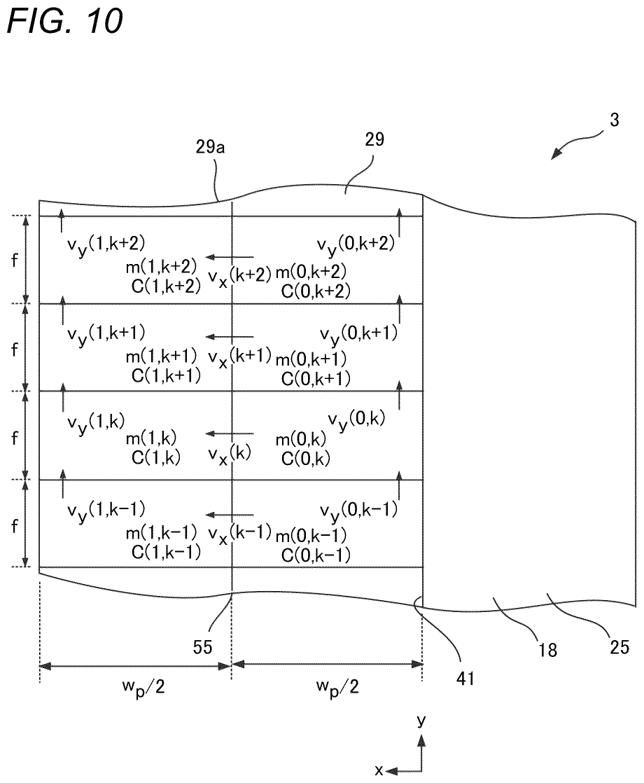

Next, step S13 is performed. That is, a change in the gas concentration due to the flow of the flight extruded molten resin 29a is calculated. FIG. 10 shows an enlarged view of a part of the meshes of the flight extruded molten resin 29a. The meshes are denoted as mesh m (0, k), m (1, k), and m (0, k+1). The flow velocity vₓ in the x direction in the mesh m (0, k) or in the mesh m (1, k) is denoted as vₓ(k), and the flow velocity v_{y} in the y direction in the mesh m (0, k) is denoted as v_{y}(0, k). As described above, the change in the gas concentration due to the flow is given by Equation (8). By integrating this, Equation (15-1) is obtained. [JP0065]

$$\int \int \frac{\partial C}{\partial l} dxdy \int \int \frac{\partial }{\partial x} ( {v}_{x} C ) dxdy + \int \int \frac{\partial }{\partial y} ( {v}_{y} C ) dxdy = 0 \qquad ( 15 - 1 )$$

where C: GAS CONCENTRATION IN MOLTEN RESIN [g/m³]
vₓ: x-DIRECTION COMPONENT OF FLOW VELOCITY OF RESIN [m/s]
v_{y}: y-DIRECTION COMPONENT OF FLOW VELOCITY OF RESIN [m/s]

$$\frac{{C}_{new} ( 0 , k ) - C ( 0 , k )}{Δ t} + \frac{2 {v}_{x} ( k ) C ( 1 , k )}{{w}_{p}} + \frac{{v}_{y} ( 0 , k ) ( C ( 0 , k + 1 ) - C ( 0 , k - 1 ) )}{f} = 0 \qquad ( 15 - 2 )$$

$$\frac{{C}_{new} ( 1 , k ) - C ( 1 , k )}{Δ t} + \frac{2 {v}_{x} ( k ) C ( 0 , k )}{{w}_{p}} + \frac{{v}_{y} ( 1 , k ) ( C ( 1 , k + 1 ) - C ( 1 , k - 1 ) )}{f} = 0 \qquad ( 15 - 3 )$$

where C_{new}(0, k): GAS CONCENTRATION IN MOLTEN RESIN AFTER ΔT SECONDS AT MESH m (0, k) [g/m³]
C(0, k): GAS CONCENTRATION IN MOLTEN RESIN AT MESH m (0, k) [g/m³]
vₓ(k): x-DIRECTION COMPONENT OF FLOW VELOCITY OF RESIN AT MESH m (0, k) OR m (1, k) [m/s]
v_{y}(0, k): y-DIRECTION COMPONENT OF FLOW VELOCITY OF RESIN AT MESH m (0, k) [m/s]
wₚ: THICKNESS OF EXCLUDED MOLTEN RESIN BY FLIGHT [m](TWICE WIDTH OF MESH IN x DIRECTION)
θ: WIDTH OF MESH IN y DIRECTION [m]

Here, when a width of the mesh in the x direction, wₚ/2, is set as dx and a width in the y direction, f, is set as dy, Equations (15-2) and (15-3) are obtained based on the notations in FIG. 10. These equations hold for any k. Based on Equations (15-2) and (15-3), the gas concentration C_{new} after Δt seconds due to flow can be calculated for each mesh. When k=0, that is, when calculation is performed for meshes m (0, 0) and m (1, 0) of the lowermost layer, C (0, −1) and C (1, −1) may be replaced with C (0, 0) and C (1, 0) in Equations (15-2) and (15-3). Similarly, when k is the maximum kₘₐₓ in the range, that is, when the calculation is performed for meshes m (0, kₘₐₓ) and m (1, kₘₐₓ) of the uppermost layer, the same may be performed.

In FIG. 9, after step S13 is performed, step S14 is performed. That is, a check is made to see whether the resin has passed through the width of the mesh in the z direction. That is, the flight extruded molten resin 29a advances in the z direction at an average velocity component in the z direction of πD_{b}N cos θ/2 (D_{b}: inner diameter of the heating cylinder 17, N: rotation speed of the screw 18, θ: flight angle). Therefore, it is considered that the entire mesh advances in the z direction at an average flow velocity v_{z}=πD_{b}N cos θ/2 in the z direction. According to the flow velocity v_{z}, in the first calculation, the flow advances in the z direction by the first Δt seconds, that is, πD_{b}N cosθΔt/2. A check is made to see whether an advanced distance has passed through the width of the mesh in the z direction. If not, the determination is NO, and the process returns to step S11.

In step S11, the calculation is performed for the next Δt seconds, that is, among the plurality of meshes of the flight extruded molten resin 29a (see FIG. 8B), for the meshes serving as the gas-liquid interface, that is, the meshes on the left side, the dissolution of the gas in a short time Δt is calculated. Next, in step S12, a change in gas concentration due to the flow is calculated. Step S13 is executed again. If the distance advanced in the z direction by the average flow velocity v_{z} has not passed through the width of the mesh in the z direction (NO), the process returns to step S11 again, and if the distance has passed (YES), the process proceeds to step S15. In step S15, the gas concentration in each mesh is transferred to the next mesh group in the z direction, that is, the downstream mesh group. That is, it is assumed that the gas concentration has moved from the upstream mesh group to the adjacent downstream mesh group due to the average flow velocity v_{z} in the z direction.

After step S15 is executed, the process proceeds to step S16. That is, it is determined whether the flight extruded molten resin 29a having a predetermined width in the z direction, which is the subject of the calculation, has passed through the non-filled section 27 (see FIG. 2). If not, the process returns to step S11 to repeat the calculation. On the other hand, if is determined that the resin has passed through (YES), the calculation ends. Alternatively, instead of step S15, the end of the calculation may be determined based on whether a metering time has elapsed. The description of the gas concentration estimation method according to the third illustrative embodiment ends.

### Gas Concentration Estimation Method according to Fourth Illustrative Embodiment

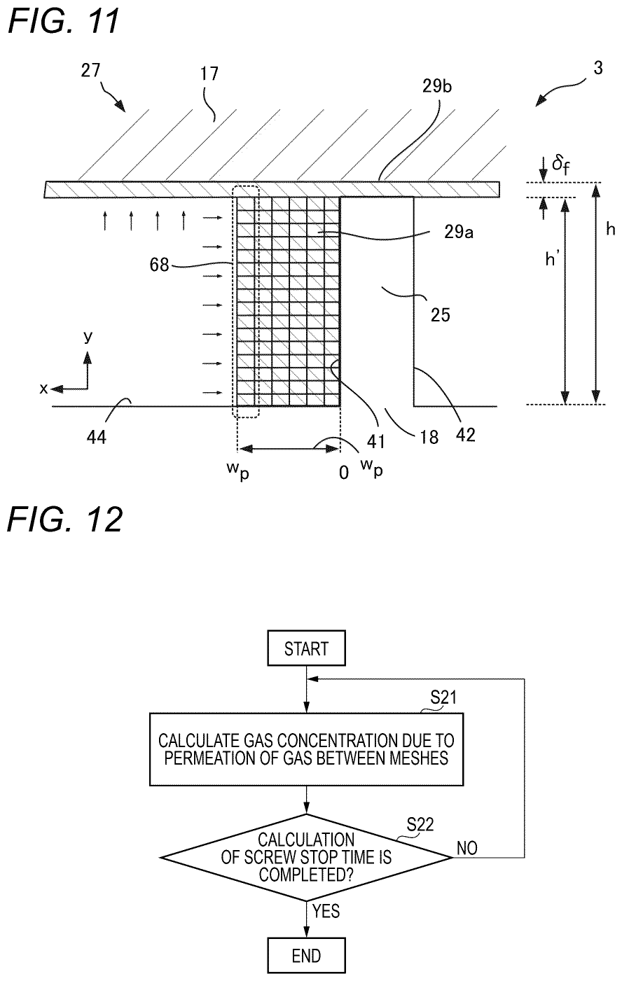

In the gas concentration estimation method according to a fourth illustrative embodiment, a change in the gas concentration of the flight extruded molten resin 29a during a period in which the rotation of the screw 18 is stopped is calculated. When the rotation of the screw 18 is stopped, as shown in FIG. 11, an inner wall of the heating cylinder 17 is stopped with respect to the screw 18, and the flow velocity of the molten resin in the flight extruded molten resin 29a becomes zero. At this time, the change in the gas concentration of the flight extruded molten resin 29a is caused only by dissolution of the gas from the gas-liquid interface and the permeation of the dissolved gas into the interior of the molten resin. When the rotation of the screw 18 is stopped, the mesh is divided finely in both the x direction and the y direction for calculation as shown in FIG. 11. When there is no flow of the molten resin, the permeation of the gas in the molten resin is given by Equation (16-1) obtained by transforming Equation (8-3).

$$\frac{\partial C}{\partial t} = {D}_{m} ( \frac{{\partial }^{2} C}{\partial {x}^{2}} + \frac{{\partial }^{2} C}{\partial {y}^{2}} + \frac{{\partial }^{2} C}{\partial {z}^{2}} ) \qquad ( 16 - 1 )$$

where C: GAS CONCENTRATION IN MOLTEN RESIN [g/m³]
Dₘ: DIFFUSION COEFFICIENT OF GAS [m²/s]

$$\frac{\partial C}{\partial t} = {D}_{m} \frac{{\partial }^{2} C}{\partial {x}^{2}} \qquad ( 16 - 2 )$$

In the gas concentration estimation method according to the fourth illustrative embodiment, the gas concentration of the meshes corresponding to the gas-liquid interface is given by the solubility C* of the gas. Then, the calculation is performed as shown in FIG. 12. That is, step S21 is executed. A change in the gas concentration due to the permeation of the gas between the meshes in the x direction, the y direction, and the z direction is calculated by Equation (16-1). Next, step S22 is performed. That is, it is determined whether the calculation of a screw stop time is completed. If not (NO), the process returns to step S21 to repeat the calculation. On the other hand, if the calculation is completed (YES), the process ends. In practice, the magnitude of the change in the gas concentration due to permeation in the y direction and the z direction is sufficiently small with respect to the change in the x direction. Therefore, Equation (16-2) obtained by transforming Equation (16-1) can be used in step S21. The amount of calculation can be reduced by performing calculation using Equation (16-2). The description of the gas concentration estimation method according to the fourth illustrative embodiment ends.

### Modifications

The gas concentration estimation method according to the present illustrative embodiment may be variously modified. For example, the gas concentration estimation method according to the second illustrative embodiment or the gas concentration estimation method according to the third illustrative embodiment may be modified. In these gas concentration estimation methods, as described in step S3 of FIG. 7 and step S14 of FIG. 9, calculation was performed until the molten resin that is the subject of the calculation passed through the non-filled section 27. That is, when the resin enters the non-filled section 27, the calculation is continued until the resin passes through.

However, when actual foam molding is performed, the rotation of the screw 18 is stopped when a necessary amount of resin is metered. Then, some of the resin passes through the non-filled section 27 and fed out, while some of the resin stops in the middle of the non-filled section 27. The resin that stops in the middle of the non-filled section 27 in this manner is held in this state for a predetermined period, that is, until an injection operation in the injection device 3 (see FIG. 2) is completed, and will be fed forward when the screw 18 rotates again. Therefore, the gas concentration estimation method according to the second illustrative embodiment or the gas concentration estimation method according to the third illustrative embodiment may be modified according to such an actual state of foam molding.

That is, when the screw 18 is rotating, the gas concentration in the molten resin is calculated by the gas concentration estimation method according to the second or third illustrative embodiment, and the completion of a metering time is also determined in step S3 of FIG. 7 or step S14 of FIG. 9. When the metering time has elapsed, for the resin that stops in the non-filled section 27, a change in the gas concentration during the stop of the screw 18 is calculated by the gas concentration estimation method according to the fourth illustrative embodiment. Then, when the screw 18 is rotated again, the gas concentration in each mesh at that time point is used as the initial condition, and the gas concentration in the molten resin may be calculated by the gas concentration estimation method according to the second or third illustrative embodiment.

### Example 1

### Experiments and Simulations

In order to examine the degree of accuracy with which the gas concentration in the molten resin can be estimated by the gas concentration estimation method according to the present illustrative embodiment, an experiment using the actual injection device 3 and a simulation by a computer were performed, and experiment result were compared with the simulation.

### Experiment Using Actual Device

An experiment was performed using the actual injection device 3 to measure gas concentration in a molten resin by permeating a gas and metering the resin. The conditions of the experiment are as follows.

### “Injection Device 3”

Inner diameter D_{b} of heating cylinder 17: 2.2×10⁻² [m]
Height h′ (≈h) of flight 25 of screw 18: 4.6×10⁻³ [m]
Gap δ_{f} between top of flight 25 and inner peripheral surface of heating cylinder 17: 7.5×10⁻⁵ [m]
Pitch of flights 25: 2.2×10⁻² [m]
Flight angle of flight 25: 0.308 [rad]
Groove width between flights: 1.88×10⁻² [m]
Number of starts of flight threads: 1 [−]
Length of non-filled section 27: 4.95×10⁻¹ [m]
Gas concentration measuring device

A heat-resistant and pressure-resistant transmission type near-infrared spectroscopic probe was attached to the injection nozzle 24 (see FIG. 2) of the injection device 3 and connected to a Fourier transform spectrophotometer via an optical fiber, so that the gas concentration in the molten resin was measured.

### “Resin and Gas”

Resin type: Polypropylene
Resin specific gravity ρ: 740 [kg/m³] (210° C.)
Gas Type: Carbon dioxide
Diffusion coefficient Dₘ of gas: 8.0×10⁻⁹ [m²/s]
Solubility C* of gas: 2.72×10⁻² [g/m³]

### “Molding Condition”

Metering stroke: 4.5×10⁻² [m]
Molding cycle time: 40 [s]
Number of molding cycles: 5 [−]

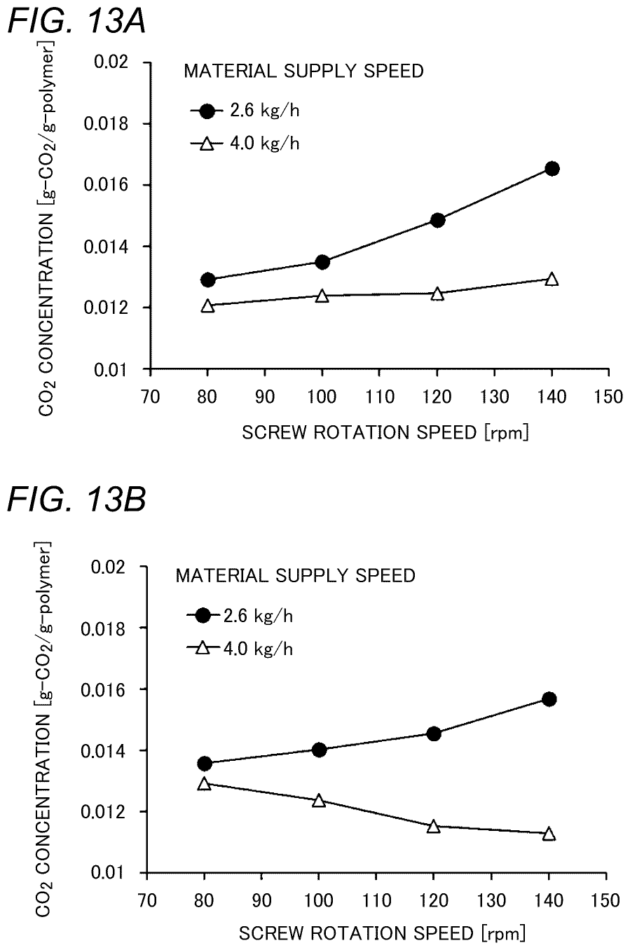

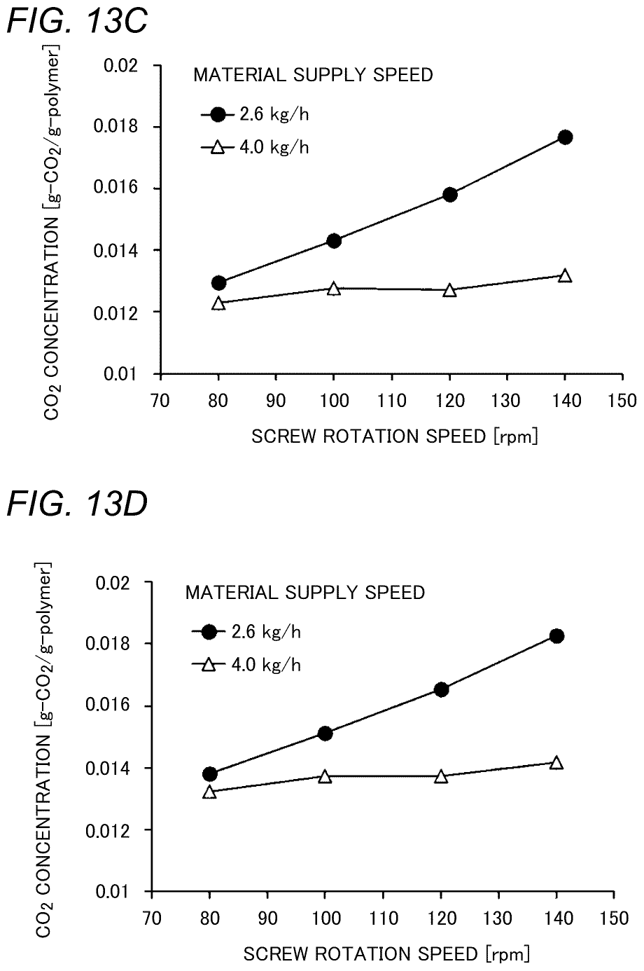

The experiment was carried out by providing a feeder in the hopper 23 so that a material supply speed was set. First, the material supply speed from the feeder was set to 2.6 kg/h, a screw rotation speed was set to 80 rpm, and molding cycles were carried out five times under the above conditions. An average value of gas concentration, that is, CO₂ concentration measured by the gas concentration measuring device was obtained. Similarly, the molding cycles were carried out 10 to 50 times for each of the screw rotation speeds of 100 rpm, 120 rpm, and 140 rpm at the material supply speed of 2.6 kg/h, and the average value of the CO₂ concentration was obtained. Next, the same experiment was carried out by changing the material supply speed. That is, the molding cycles were carried out 10 to 50 times for each of the screw rotation speeds of 80 rpm, 100 rpm, 120 rpm, and 140 rpm at the material supply speed of 4.0 kg/h, and the average value of the CO₂ concentration was obtained. The obtained results are shown in FIG. 13A.

Even if the material supply speed by the feeder is controlled, the volume flow rate Qₘ flowing through the heating cylinder 17 does not reach the material supply speed when the screw rotation speed is small. Further, even when the screw rotation speed is sufficiently high, the volume flow rate Qₘ does not necessarily coincide with the material supply speed. Therefore, when the above experiment was carried out, the volume flow rate Qₘ of the material that actually flowed in the heating cylinder 17 was measured and recorded for each combination of the set material supply speed and screw rotation speed. The recorded volume flow rate Qₘ is used in the simulation described below. When the material supply speed or the screw rotation speed changes, the metering time inevitably changes, and thus the stop time of the screw 18 also changes. The stop time of the screw 18 is a time obtained by subtracting the metering time from the molding cycle time of 40 seconds. Therefore, the actual metering time and stop time were measured and recorded for each combination of the set material supply speed and screw rotation speed. This is also used in the simulation described below.

### Simulation 1

The gas concentration in the molten resin was calculated by the gas concentration estimation method according to the first illustrative embodiment. Specifically, Equations (2-6) and (6-1) were used, and the simulation was performed based on the same conditions as those of the experiment. In the simulation by the gas concentration estimation method according to the first illustrative embodiment, the calculation was performed only when the screw 18 was rotating, without taking into consideration a time when the screw 18 was stopped. Results of the simulation are shown in FIG. 13B.

### Simulation 2

The gas concentration in the molten resin was calculated by the gas concentration estimation method according to the third illustrative embodiment. That is, the calculation was performed according to the flowchart of FIG. 9. The mesh of the flight extruded molten resin 29a was divided as follows. That is, the number of divisions in the x direction of the mesh was two, the number of divisions in the y direction was 200, and a length of the mesh in the z direction was 3.63×10⁻³ [m]. In simulation 2, the calculation was also performed only when the screw 18 was rotating, without taking into consideration a time when the screw 18 was stopped. Results of the simulation are shown in FIG. 13C.

### Simulation 3

The gas concentration in the molten resin was calculated by combining the gas concentration estimation method according to the third illustrative embodiment and the gas concentration estimation method according to the fourth illustrative embodiment. That is, when the screw 18 was rotating, calculation was performed by the gas concentration estimation method according to the third illustrative embodiment, and when the screw 18 was stopped, calculation was performed by switching to the gas concentration estimation method according to the fourth illustrative embodiment. The division of the mesh of the flight extruded molten resin 29a was changed depending on whether the screw 18 was rotating or not. That is, when the screw 18 was rotating, the number of divisions in the x direction of the mesh was two, the number of divisions in the y direction was 200, and the length of the mesh in the z direction was 3.63×10⁻³ [m]. On the other hand, when the screw 18 was stopped, the number of divisions in the x direction of the mesh was 200, the number of divisions in the y direction was 200, and the length of the mesh in the z direction was 3.63×10⁻³ [m]. That is, the number of divisions in the x direction was switched. Results of the simulation are shown in FIG. 13D.

### Discussion

It was confirmed that, in all simulations 1, 2, and 3, gas concentrations close to those obtained in the experiment were obtained. It was also found that the gas concentration estimation method according to the third illustrative embodiment can calculate gas concentrations with values closer to the results obtained by the experiment than the gas concentration estimation method according to the first illustrative embodiment. That is, it was confirmed that in estimation of the gas concentration, the gas concentration can be estimated with higher accuracy by taking into account not only the dissolution of the gas from the gas-liquid interface but also the flow of the molten resin.

In this regard, in simulation 3, calculation was performed taking into consideration of the diffusion of the gas while the screw 18 was stopped, and the gas concentration was calculated to be greater than the gas concentration obtained in the experiment. In all simulations 1, 2, and 3, calculations were performed assuming that the length of the non-filled section 27 was fixed, but the length of the non-filled section 27 actually changes. It is presumed that the calculated gas concentration was high as a result of the simulation not taking into account the change in length. Therefore, in order to estimate the gas concentration with higher accuracy, it is preferable to perform simulation using a model in which the length of the non-filled section 27 changes. The change in length of the non-filled section 27 may be obtained by an actual experiment or may be obtained by calculation using flow analysis software.

Although the invention made by the present inventor has been specifically described above based on the illustrative embodiments, it is needless to say that the present invention is not limited to the illustrative embodiments described above, and various modifications can be made without departing from the scope of the invention. The plurality of examples described above may be appropriately combined.

1. A gas concentration estimation method used in an injection device for foam molding,
the injection device including:
a heating cylinder;
a screw inserted into the heating cylinder and on which a flight is formed; and
a gas supply unit,
wherein the injection device is configured to: melt a resin and feed the resin downstream by rotating the screw in the heating cylinder; form a non-filled section in which molten resin is depressurized and the heating cylinder becomes a non-filled state due to a shape of the flight; and cause the gas supply unit to supply gas to the non-filled section, such that the gas dissolves in the molten resin, and
wherein a change rate dC/dt of gas concentration in molten resin, resulting from the gas dissolving into the molten resin via a gas-liquid interface between the gas and the molten resin in the non-filled section during rotation of the screw, is given by following equation (c1)
$$\frac{dC}{dt} = k ( {C}^{*} - C ) \qquad ( c1 )$$
where dC/dt: CHANGE RATE OF GAS CONCENTRATION IN MOLTEN RESIN [g/(m³s)]
k: CONSTANT [s]
C*: SOLUBILITY OF GAS [g/m³]
C: GAS CONCENTRATION IN MOLTEN RESIN [g/m³]
the gas concentration estimation method comprising:
estimating the gas concentration in the molten resin from the equation (c1) and a passing time T, which represents a time required for the resin to pass through the non-filled section.

2. The gas concentration estimation method according to claim 1, wherein the method comprises estimating the gas concentration in the molten resin by using following equation (c4)
$$C = ( 1 - exp ( - kT ) ) {C}^{*} \qquad ( c4 )$$
where k: CONSTANT [/s]
T: PASSING TIME THROUGH NON-FILLED SECTION [s]
C*: SOLUBILITY OF GAS [g/m³]
which is obtained based on the equation (c1).

3. The gas concentration estimation method according to claim 1,
wherein assuming that the gas-liquid interface is renewed due to flow of the molten resin extruded by the flight in the non-filled section, an amount N_{gs} of gas dissolving from the gas-liquid interface into the molten resin per unit time is given by following equation (c2)
$${N}_{gx} = 2 √ \frac{\overline{{D}_{m}}}{πτ} ( {C}^{*} - C ) \qquad ( c2 )$$
where N_{gs}: AVERAGE DISSOLUTION RATE OF GAS [g/(m²s)]
Dₘ: DIFFUSION COEFFICIENT OF GAS [m²/s]
τ: EXPOSURE TIME OF GAS [g/m³]
C*: SOLUBILITY OF GAS [g/m³]
C: GAS CONCENTRATION IN MOLTEN RESIN [g/m³]
wherein the method comprises obtaining k in the equation (c1) and estimating the gas concentration in the molten resin.

4. The gas concentration estimation method according to claim 1,
wherein when one of a pair of wall surfaces of the flight is defined as a push surface that extrudes the molten resin as the screw rotates, and the other is defined as a pull surface, the molten resin is extruded by coming into contact with the push surface in the non-filled section, and a thickness wp of the extruded molten resin in a direction orthogonal to the flight is assumed to be constant, and
wherein the method comprises estimating the gas concentration in the molten resin by giving a coefficient k by following equation (c3)
$$k = \frac{2}{{w}_{p}} √ \frac{\overline{{D}_{m} {D}_{b} N sin θ}}{h} \qquad ( c3 )$$
where wₚ: THICKNESS OF MOLTEN RESIN ON PUSH SURFACE OF FLIGHT [m]
Dₘ: DIFFUSION COEFFICIENT OF GAS [m²/s]
D_{b}: INNER DIAMETER OF HEATING CYLINDER [m]
N: ROTATION SPEED OF SCREW [/s]
θ: FLIGHT ANGLE [rad]
h DISTANCE BETWEEN GROOVE BETWEEN FLIGHTS AND INNER PERIPHERAL SURFACE OF HEATING CYLINDER [m]

5. The gas concentration estimation method according to claim 1, the method comprising:
calculating, for the molten resin extruded in the non-filled section, the gas concentration C in the molten resin, which increases based on an amount of dissolved gas, for a predetermined time interval based on the equation (c1);
repeating the calculation for successive predetermined time intervals until the passing time T is reached; and
estimating the gas concentration in the molten resin.

6. The gas concentration estimation method according to claim 5,
wherein when one of a pair of wall surfaces of the flight is defined as a push surface that extrudes the molten resin as the screw rotates, and the other is defined as a pull surface, the molten resin is extruded by coming into contact with the push surface in the non-filled section, and a thickness Wp of the extruded molten resin in a direction orthogonal to the flight is assumed to be constant,
wherein the method comprises estimating the gas concentration in the molten resin by giving a coefficient k by following equation (c3)
$$k = \frac{2}{{w}_{p}} √ \frac{\overline{{D}_{m} {D}_{b} N sin θ}}{h} \qquad ( c3 )$$
where wₚ: THICKNESS OF MOLTEN RESIN ON PUSH SURFACE OF FLIGHT [m]
Dₘ: DIFFUSION COEFFICIENT OF GAS [m²/s]
D_{b}: INNER DIAMETER OF HEATING CYLINDER [m]
N: ROTATION SPEED OF SCREW [s]
θ: FLIGHT ANGLE [rad]
h: DISTANCE BETWEEN GROOVE BETWEEN FLIGHTS AND INNER PERIPHERAL SURFACE OF HEATING CYLINDER [m]

7. The gas concentration estimation method according to claim 1,
wherein when one of a pair of wall surfaces of the flight is defined as a push surface that extrudes the molten resin as the screw rotates and the other is defined as a pull surface, the molten resin is extruded by the push surface to a predetermined thickness in the non-filled section, the gas fills a space between the molten resin and the pull surface, and a gas-liquid interface is formed,
wherein the molten resin having a predetermined thickness extruded by the push surface is divided into a plurality of element resins in each of a direction along a spiral of the flight, a thickness direction of the molten resin, and a height direction of the flight, and the gas concentration inside each of the element resins is treated as being uniform at any given moment, and
wherein the method comprises:
calculating dissolution of the gas into the molten resin from the gas-liquid interface by the equation (c1) only for the element resin that is in contact with the gas among the plurality of element resins; and
estimating the gas concentration in the molten resin by treating the plurality of element resins as moving and mixing with the rotation of the screw.

8. The gas concentration estimation method according to claim 7,
wherein when one of a pair of wall surfaces of the flight is defined as a push surface that extrudes the molten resin as the screw rotates and the other is defined as a pull surface, the molten resin is extruded by coming into contact with the push surface in the non-filled section, a thickness wp of the extruded molten resin in a direction orthogonal to the flight is assumed to be constant, and the molten resin is divided such that the plurality of element resins have a uniform thickness dx, and
wherein the method comprises estimating the gas concentration in the molten resin by giving a coefficient k by following equation (c5)
$$k = \frac{2}{{d}_{x}} √ \frac{\overline{{D}_{m} {D}_{b} N sin θ}}{h} \qquad ( c5 )$$
where dₓ: THICKNESS OF ELEMENT RESIN (DEPTH FROM GAS-LIQUID INTERFACE) [m]
Dₘ: DIFFUSION COEFFICIENT OF GAS [m²/s]
D_{b}: INNER DIAMETER OF HEATING CYLINDER [m]
N: ROTATION SPEED OF SCREW [/s]
θ: FLIGHT ANGLE [rad]
h: DISTANCE BETWEEN GROOVE BETWEEN FLIGHTS AND INNER PERIPHERAL SURFACE OF HEATING CYLINDER [m]

9. The gas concentration estimation method according to claim 7, wherein the method comprises estimating the gas concentration in the molten resin by treating film-shaped molten resin that adheres to an inner peripheral surface of the heating cylinder and that is in contact with the gas in the non-filled section as being taken into the molten resin extruded by the flight as the screw rotates.

10. The gas concentration estimation method according to claim 9, wherein the method comprises estimating the gas concentration in the molten resin by treating a gas concentration in the film-shaped molten resin as being equal to the solubility C* of the gas.

11. The gas concentration estimation method according to claim 7, wherein the method comprises estimating the gas concentration in the molten resin by treating a change in the gas concentration in the molten resin due to permeation of the gas into the molten resin in the non-filled section, when the rotation of the screw is stopped, as being given by following equation (c6)
$$\frac{\partial C}{\partial t} = {D}_{m} \frac{{\partial }^{2} C}{\partial {x}^{2}} \qquad ( c6 )$$
where Dₘ: DIFFUSION COEFFICIENT OF GAS [m²/s]
x: THICKNESS DIRECTION OF MOLTEN RESIN EXTRUDED BY FLIGHT (DIRECTION PERPENDICULAR TO FLIGHT)
C=C* AT GAS-LIQUID INTERFACE
